(19) United States
(12) Patent Application Publication
(10) Pub. No.: US 2025/0203509 A1
(43) Pub. Date: Jun. 19, 2025

(54) Wake-on-WLAN device and method

(71) Applicant: Realtek Semiconductor Corporation, Hsinchu (TW)

(72) Inventor: PO-CHUAN LIN, Hsinchu (TW)

(21) Appl. No.: 18/973,157

(22) Filed: Dec. 9, 2024

(30) Foreign Application Priority Data
Dec. 13, 2023 (TW) 112148585

(51) Int. Cl. H04W 52/02; H04W 84/12

(52) U.S. Cl. CPC H04W 52/0206; H04W 84/12

(57) ABSTRACT

A Wake-on-WLAN device includes a Wi-Fi circuit, a general-purpose input/output (GPIO) interface, and a system circuit, wherein the Wi-Fi circuit is coupled to the system circuit through the GPIO interface. After the Wi-Fi circuit enters a to-be-waked phase, when the Wi-Fi circuit needs to wake up the system circuit according to a wake-up event, the Wi-Fi circuit generates a GPIO signal and transmits the GPIO signal to the system circuit via the GPIO interface, wherein the waveform of the GPIO signal varies with the type of the wake-up event. After the system circuit enters the to-be-waked phase, when the system circuit receives the GPIO signal from the Wi-Fi circuit, the system circuit wakes up according to the GPIO signal, and then determines the type of the wake-up event according to the waveform of the GPIO signal to act according to the type of the wake-up event.

### BACKGROUND OF THE INVENTION

### 1. Field of the Invention

The present disclosure relates to wake-up device, especially to a Wake-on-WLAN device and a Wake-on-WLAN method.

### 2. Description of Related Art

Some electronic device (e.g., a digital television (TV)) not only includes a system circuit (e.g., a TV system on a chip (TV SoC)) for executing general TV functions but also includes a Wi-Fi circuit for realizing additional functions. In order to save power, the system circuit and the Wi-Fi circuit enter a sleep mode under predetermined conditions. When both the system circuit and the Wi-Fi circuit enter the sleep mode: if the Wi-Fi circuit receives a wake-up packet (e.g., a magic packet from an access point (AP) or some device such as a mobile device or a computer), the Wi-Fi circuit transmits a general-purpose input/output (GPIO) signal to the system circuit via a GPIO interface to awaken the system circuit while the system circuit does not know why it is waked up; next, the system circuit keeps executing a wake-up procedure according to the GPIO signal till it recognizes the Wi-Fi circuit, and then the system circuit inquires why the Wi-Fi circuit wakes it up from the Wi-Fi circuit. In order to complete the above-mentioned wake-up procedure, a fast system (e.g., a laptop computer) generally consumes hundreds of milliseconds while a slow embedded system probably consumes a few seconds. Since the wake-up procedure takes a lot of time, it results in a bad user experience.

Regarding the prior arts, there are three common ways to awaken a system circuit with a GPIO signal as follows:
(1) GPIO edge trigger: awakening the system circuit with the rising edge or the falling edge of a GPIO signal;
(2) GPIO level trigger: awakening the system circuit with a GPIO signal of a predetermined voltage level; and
(3) GPIO pulse trigger: awakening the system circuit with a square wave functioning as a GPIO signal.

However, all the above-mentioned three ways cannot inform the system circuit of the reason it is waked up.

In addition, as to the prior arts, in a circumstance that the Wi-Fi circuit is in the sleep mode while the system circuit is not in the sleep mode, when the Wi-Fi circuit transmits the GPIO signal to the system circuit to try to awaken the system circuit and make it take appropriate actions (e.g., turning on a monitor, or processing some specific packets without turning on the monitor), the system circuit, that is not in the sleep mode, disregards the GPIO signal; afterwards, even though the system circuit enters the sleep mode, the system circuit will not take any action in response to the previously received GPIO signal. Under the above condition, the system circuit will miss the GPIO signal and will not be waked up to take appropriate actions.

### SUMMARY OF THE INVENTION

The present disclosure describes a Wake-on-WLAN (WoWLAN) device and a Wake-on-WLAN method that can prevent the problems of the prior arts.

An embodiment of the Wake-on-WLAN device of the present disclosure includes a Wi-Fi circuit, a general-purpose input/output (GPIO) interface, and a system circuit, wherein the Wi-Fi circuit is coupled to the system circuit through the GPIO interface. After the Wi-Fi circuit enters a to-be-waked phase, when the Wi-Fi circuit is going to wake up the system circuit according to a wake-up event, the Wi-Fi circuit generates a GPIO signal and transmits the GPIO signal to the system circuit via the GPIO interface, wherein the waveform of the GPIO signal varies with the type of the wake-up event. When the wake-up event is a first event, the waveform of the GPIO signal is a first waveform; and when the wake-up event is a second event, the waveform of the GPIO signal is a second waveform, wherein the first waveform is different from the second waveform. After the system circuit enters the to-be-waked phase, when the system circuit receives the GPIO signal from the Wi-Fi circuit, the system circuit wakes up according to the GPIO signal, then determines the type of the wake-up event according to the waveform of the GPIO signal, and then takes an action according to the type of the wake-up event.

An embodiment of the Wake-on-WLAN method of the present disclosure is executed by a Wi-Fi circuit. This embodiment includes the following steps: after the Wi-Fi circuit enters a to-be-waked phase, when the Wi-Fi circuit is going to wake up a system circuit according to a wake-up event, using the Wi-Fi circuit to generate a GPIO signal and transmit the GPIO signal to the system circuit via a GPIO interface, wherein the waveform of the GPIO signal varies with the type of the wake-up event. When the wake-up event is a first event, the waveform of the GPIO signal includes a first waveform; and when the wake-up event is a second event, the waveform of the GPIO signal includes a second waveform, wherein the first waveform is different from the second waveform.

Another embodiment of the Wake-on-WLAN method of the present disclosure is executed by a system circuit. This embodiment includes the following steps: after the system circuit enters a to-be-waked phase, when the system circuit receives a GPIO wake-up signal from a Wi-Fi circuit, awakening the system circuit and then using the system circuit to determine the type of a wake-up event according to the waveform of the GPIO wake-up signal and to take an action according to the type of the wake-up event, wherein the waveform of the GPIO wake-up signal varies with the type of the wake-up event. When the wake-up event is a first event, the waveform of the GPIO wake-up signal is a first waveform; and when the wake-up event is a second event, the waveform of the GPIO wake-up signal is a second waveform, wherein the first waveform is different from the second waveform.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of the Wake-on-WLAN device of the present disclosure.

FIG. 2 shows an embodiment of the Wake-on-WLAN method of the present disclosure.

FIG. 3 shows another embodiment of the Wake-on-WLAN method of the present disclosure.

### DETAILED DESCRIPTION OF THE PREFERRED EMBODIMENTS

The present specification discloses a Wake-on-WLAN (WoWLAN) device and a Wake-on-WLAN method. The device and the method allow a system circuit to find out the reason it is waked up according to the waveform of a general-purpose input/output (GPIO) signal so that the system circuit can quickly take actions according to the reason.

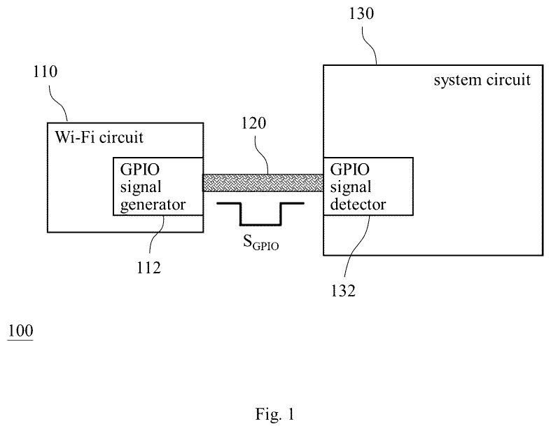

FIG. 1 shows an embodiment of the Wake-on-WLAN device of the present disclosure. The Wake-on-WLAN device 100 of FIG. 1 includes a Wi-Fi circuit 110, a GPIO interface 120, and a system circuit 130. The Wi-Fi circuit 110 includes a GPIO signal generator 112 and is coupled to the system circuit 130 through the GPIO interface 120. The system circuit 130 includes a GPIO signal detector 132.

Referring to FIG. 1, in order to save power, the Wake-on-WLAN device 100 enters a to-be-waked phase under predetermined conditions that can be determined according to implementation needs, wherein the system circuit 130 enters a sleep mode in the to-be-waked phase while the Wi-Fi circuit 110 enters a low-power mode in the to-be-waked phase and wakes up periodically to check whether any packet is waiting to be received or any event is waiting to be processed. In the to-be-waked phase, when the Wi-Fi circuit 110 is going to awaken the system circuit 130 according to a wake-up event (e.g., an event that the Wi-Fi receives a specific packet, or the Wi-Fi circuit has its own problem such as the Wi-Fi circuit 110 finding that its connection with an access point (AP) is disconnected), the Wi-Fi circuit 110 generates a GPIO signal S_{GPIO} having a specific waveform and then transmits the GPIO signal S_{GPIO} to the system circuit 130 via the GPIO interface 120, wherein the waveform of the GPIO signal S_{GPIO} varies with the type of the wake-up event. When the system circuit 130 is in the to-be-waked phase, if the GPIO signal detector 132 of the system circuit 130 receives the GPIO signal S_{GPIO} from the Wi-Fi circuit 110, the GPIO signal detector 132 has the system circuit 130 wake up according to the GPIO signal S_{GPIO} to determine the type of the wake-up event according to the waveform of the GPIO signal S_{GPIO} and thereby the system circuit 130 can take an action in response to the type of the wake-up event.

Referring to FIG. 1, when the Wi-Fi circuit 110 determines that the wake-up event is a first event, the Wi-Fi circuit 110 uses the GPIO signal generator 112 to generate the GPIO signal S_{GPIO} having a first waveform; and when the Wi-Fi circuit 110 determines that the wake-up event is a second event, the Wi-Fi circuit 110 uses the GPIO signal generator 112 to generate the GPIO signal S_{GPIO} having a second waveform, wherein the first waveform is different from the second waveform. In an exemplary implementation, the Wake-on-WLAN device 100 is a digital television (TV) including a monitor, and after the Wi-Fi circuit 110 of the Wake-on-WLAN device 100 receives a wake-up packet and is waked up by the packet:
(1) when the Wi-Fi circuit 110 determines that the wake-up event indicates “processing a specific packet that is out of the Wi-Fi circuit 110's processing power”: the Wi-Fi circuit 110 uses the GPIO signal generator 112 to generate a wave (e.g., a square wave) of a first width (e.g., 20 milliseconds between the rising edge of a square wave and the following falling edge of the same square wave) as the GPIO signal S_{GPIO}, and then the Wi-Fi circuit 110 transmits the GPIO signal S_{GPIO} to the system circuit 130 via the GPIO interface 120; and after the GPIO signal detector 132 detects the GPIO signal S_{GPIO}, the GPIO signal detector 132 has the system circuit 130 wake up according to the GPIO signal S_{GPIO} to determine the type of the wake-up event according to the waveform of the GPIO signal S_{GPIO} and thereby the system circuit 130 can handle the specific packet without turning on the aforementioned monitor and then return to the to-be-waked phase. It is noted that when the system circuit 130 is in the to-be-waked phase, the GPIO signal detector 132 stays awake for detection.
(2) when the Wi-Fi circuit 110 determines that the wake-up event indicates “turning on the monitor”: the Wi-Fi circuit 110 uses the GPIO signal generator 112 to generate a wave (e.g., a square wave) of a second width (e.g., 60 milliseconds between the rising edge of a square wave and the following falling edge of the same square wave) as the GPIO signal S_{GPIO}, and then the Wi-Fi circuit 110 transmits the GPIO signal S_{GPIO} to the system circuit 130 via the GPIO interface 120; and after the GPIO signal detector 132 detects the GPIO signal S_{GPIO}, the GPIO signal detector 132 has the system circuit 130 wake up according to the GPIO signal S_{GPIO} to determine the type of the wake-up event according to the waveform of the GPIO signal S_{GPIO} and thereby the system circuit 130 can turn on the monitor.
(3) when the Wi-Fi circuit 110 determines that the wake-up event includes “a disconnection between the Wi-Fi circuit 110 and an access point (AP)”: the Wi-Fi circuit 110 uses the GPIO signal generator 112 to generate a wave (e.g., a square wave) of a third width (e.g., 80 milliseconds between the rising edge of a square wave and the following falling edge of the square wave) as the GPIO signal S_{GPIO}, and then the Wi-Fi circuit 110 transmits the GPIO signal S_{GPIO} to the system circuit 130 via the GPIO interface 120; and after the GPIO signal detector 132 detects the GPIO signal S_{GPIO}, the GPIO signal detector 132 has the system circuit 130 wake up according to the GPIO signal S_{GPIO} to determine the type of the wake-up event according to the waveform of the GPIO signal S_{GPIO} and thereby the system circuit 130 can set the Wi-Fi circuit 110 to a disconnection and AP-searching mode without turning on the monitor and then return to the to-be-waked phase.

It is noted that the Wi-Fi circuit 110 may enter the to-be-waked phase at a time earlier than the time of the system circuit 130 entering the to-be-waked phase, which implies that the Wi-Fi circuit 110 may transmit the GPIO signal S_{GPIO} to the system circuit 130 before the system circuit 130 enters the to-be-waked phase, and thus the system circuit 130 may disregard the GPIO signal S_{GPIO} and take no action. In order to ensure that the system circuit 130 receives the GPIO signal S_{GPIO} in the to-be-waked phase: after the Wi-Fi circuit enters the to-be-waked phase, when the Wi-Fi circuit 110 wants to awaken the system circuit 130 according to the wake-up event, the Wi-Fi circuit 110 optionally/uniformly generates a plurality of the GPIO signals S_{GPIO} (e.g., a fixed number of signals such as a few signals, a dozen signals, or dozens of signals), or repeatedly generates the GPIO signal S_{GPIO} for a predetermined time, or keeps generating the GPIO signal S_{GPIO} till the system circuit 130 responds to the GPIO signal S_{GPIO}, and the Wi-Fi circuit 110 transmits the GPIO signals S_{GPIO} to the system circuit 130 in sequence via the GPIO interface 120. Accordingly, after the system circuit 130 enters the to-be-waked phase, the system circuit 130 receives at least one signal of the GPIO signals S_{GPIO} and is waked up by the at least one signal, then the system circuit 130 determines the type of the wake-up event according to the waveform of the at least one signal and then takes an action according to the type of the wake-up event. It is noted that if the system circuit 130 receives one or more of the GPIO signals S_{GPIO} before it enters the to-be-waked phase, the system circuit 130 disregards the one or more of the GPIO signals S_{GPIO} or executes some predetermined procedure which can be determined according to implementation needs.

In an exemplary implementation, the GPIO signal generator 112 includes a known or self-developed width-adjustable pulse generator (not shown in the figures) for generating the GPIO signal S_{GPIO}. In an exemplary implementation, the GPIO signal detector 132 includes a known or self-developed central processor (not shown in the figures) configured to execute firmware to determine the width of the GPIO signal S_{GPIO} and thereby determine the type of the wake-up event. In an exemplary implementation, the GPIO signal generator 132 includes a known or self-developed waveform detection hardware circuit (not shown in the figures) configured to determine the width of the GPIO signal S_{GPIO} and thereby determine the type of the wake-up event. For example, the waveform detection hardware circuit includes a counter, and the counter is configured to start counting from a first edge (e.g., a rising edge or a falling edge) of the GPIO signal S_{GPIO} (e.g., a square wave) and stop counting from a second edge (e.g., a falling edge when the first edge is a rising edge, or a rising edge when the first edge is a falling edge) of the GPIO signal S_{GPIO} and thereby generate a count value corresponding to the width of the GPIO signal S_{GPIO}.

In an exemplary implementation, the system circuit 130 includes at least one of the following circuits: a video circuit; and an audio circuit. For example, the system circuit 130 is one of the following circuits: a television system on a chip (TV SoC); a set-top box integrated circuit (STB IC); and a smart speaker circuit.

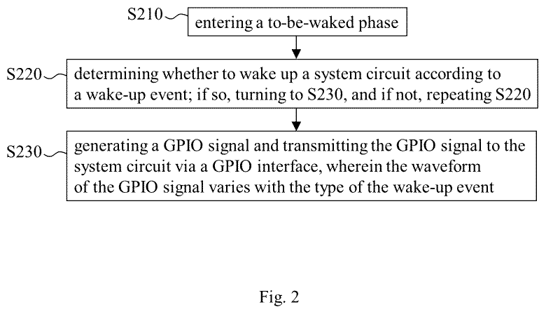

FIG. 2 shows an embodiment of the Wake-on-WLAN method of the present disclosure. This embodiment is performed by a Wi-Fi circuit (e.g., the Wi-Fi circuit 110 of FIG. 1), and includes the following steps:
S210: entering a to-be-waked phase;
S220: after the step S210, determining whether to wake up a system circuit (e.g., the system circuit 130 of FIG. 1) according to a wake-up event; if so, turning to the step S230, and if not, repeating the step S220; and
S230: generating a GPIO signal and transmitting the GPIO signal to the system circuit via a GPIO interface (e.g., the GPIO interface 120 of FIG. 1), wherein the waveform of the GPIO signal varies with the type of the wake-up event.
   When the wake-up event is a first event, the waveform of the GPIO signal is or includes a first waveform; and when the wake-up event is a second event, the waveform of the GPIO signal is or includes a second waveform, wherein the first waveform is different from the second waveform. For example, the width of the first waveform is different from the width of the second waveform and this width difference is detectable (e.g., the width difference is detectable to the GPIO signal detector 132 of FIG. 1).

Since those having ordinary skill in the art can refer to the embodiment of FIG. 1 to appreciate the detail and the modification of the embodiment of FIG. 2, repeated and redundant description is omitted here.

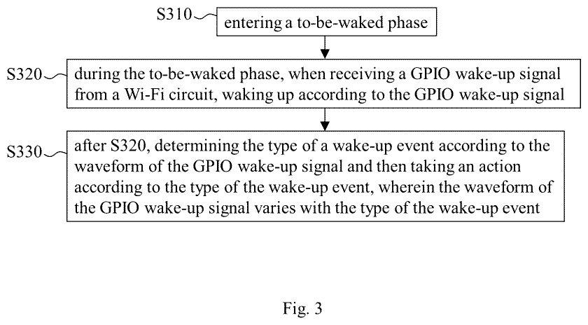

FIG. 3 shows another embodiment of the Wake-on-WLAN method of the present disclosure. This embodiment is performed by a system circuit (e.g., the system circuit 130 of FIG. 1), and includes the following steps:
S310: entering a to-be-waked phase;
S320: during the to-be-waked phase, when receiving a GPIO wake-up signal (e.g., the GPIO signal S_{GPIO} in FIG. 1) from a Wi-Fi circuit (e.g., the Wi-Fi circuit 110 of FIG. 1), waking up according to the GPIO wake-up signal.
S330: after the step S320, determining the type of a wake-up event according to the waveform of the GPIO wake-up signal and then taking an action according to the type of the wake-up event, wherein the waveform of the GPIO wake-up signal varies with the type of the wake-up event.

Since those having ordinary skill in the art can refer to the embodiment of FIGS. 1˜2 to appreciate the detail and the modification of the embodiment of FIG. 3, repeated and redundant description is omitted here.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention is flexible based on the present disclosure.

To sum up, the Wake-on-WLAN device and the Wake-on-WLAN method of the present disclosure allow an awakened system circuit to determine the reason why it is waked up according to the waveform of a GPIO signal so that the system circuit can promptly act in response to the reason.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A Wake-on-WLAN device comprising a Wi-Fi circuit, a general-purpose input/output (GPIO) interface, and a system circuit, wherein:
the Wi-Fi circuit is coupled to the system circuit through the GPIO interface;
after the Wi-Fi circuit enters a to-be-waked phase, when the Wi-Fi circuit is going to wake up the system circuit according to a wake-up event, the Wi-Fi circuit generates a GPIO signal and transmits the GPIO signal to the system circuit via the GPIO interface, wherein a waveform of the GPIO signal varies with a type of the wake-up event, the waveform of the GPIO signal is a first waveform when the wake-up event is a first event, the waveform of the GPIO signal is a second waveform when the wake-up event is a second event, and the first waveform is different from the second waveform; and
after the system circuit enters the to-be-waked phase, when the system circuit receives the GPIO signal from the Wi-Fi circuit, the system circuit wakes up according to the GPIO signal, then determines the type of the wake-up event according to the waveform of the GPIO signal, and then takes an action according to the type of the wake-up event.

2. The Wake-on-WLAN device of claim 1, wherein the first waveform includes a first square waveform, the second waveform includes a second square waveform, a width of the first square waveform is different from a width of the second square waveform, and the system circuit includes:
a central processor configured to execute firmware to determine a width of the waveform of the GPIO signal and thereby determine the type of the wake-up event.

3. The Wake-on-WLAN device of claim 1, wherein the first waveform includes a first square waveform, the second waveform includes a second square waveform, a width of the first square waveform is different from a width of the second square waveform, and the system circuit includes:
a waveform detection hardware circuit configured to determine a width of the waveform of the GPIO signal and thereby determine the type of the wake-up event.

4. The Wake-on-WLAN device of claim 3, wherein the waveform detection hardware circuit includes a counter, and the counter is configured to start counting from a first edge of the waveform of the GPIO signal and stop counting from a second edge of the waveform of the GPIO signal so as to generate a count value corresponding to the width of the waveform of the GPIO signal.

5. The Wake-on-WLAN device of claim 1, wherein:
after the Wi-Fi circuit enters the to-be-waked phase, when the Wi-Fi circuit is going to wake up the system circuit according to the wake-up event, the Wi-Fi circuit generates a plurality of signals and transmits the plurality of signals to the system circuit in sequence via the GPIO interface, wherein each of the plurality of signals is the GPIO signal; and
after the system circuit enters the to-be-waked phase, when the system circuit receives at least one signal of the plurality of signals from the Wi-Fi circuit, the system circuit wakes up, determines the type of the wake-up event according to the at least one signal of the plurality of signals, and then takes the action according to the type of the wake-up event.

6. The Wake-on-WLAN device of claim 5, wherein the Wi-Fi circuit enters the to-be-waked phase at a time earlier than a time of the system circuit entering the to-be-waked phase.

7. The Wake-on-WLAN device of claim 6, wherein before the system circuit enters the to-be-waked phase, when the system circuit receives one or more of the plurality of signals, the system circuit disregards the one or more of the plurality of signals.

8. The Wake-on-WLAN device of claim 1, wherein the system circuit includes at least one of following circuits: a video circuit; and an audio circuit.

9. The Wake-on-WLAN device of claim 8, wherein the system circuit is a television system on a chip (TV SoC), a set-top box integrated circuit (STB IC), or a smart speaker circuit.

10. The Wake-on-WLAN device of claim 1, wherein the system circuit determines whether to turn on a monitor according to the type of the wake-up event.

11. A Wake-on-WLAN method executed by a Wi-Fi circuit, the Wake-on-WLAN method comprising:
after the Wi-Fi circuit enters a to-be-waked phase, when the Wi-Fi circuit is going to wake up a system circuit according to a wake-up event, using the Wi-Fi circuit to generate a general-purpose input/output (GPIO) signal and transmit the GPIO signal to the system circuit via a GPIO interface,
wherein a waveform of the GPIO signal varies with a type of the wake-up event, the waveform of the GPIO signal includes a first waveform when the wake-up event is a first event, the waveform of the GPIO signal includes a second waveform when the wake-up event is a second event, and the first waveform is different from the second waveform.

12. The Wake-on-WLAN method of claim 11, wherein a width of the first waveform is different from a width of the second waveform.

13. The Wake-on-WLAN method of claim 11, wherein:
after the Wi-Fi circuit enters the to-be-waked phase, when the Wi-Fi circuit is going to wake up the system circuit according to the wake-up event, using the Wi-Fi circuit to generate a plurality of signals and transmit the plurality of signals to the system circuit via the GPIO interface to ensure that the system circuit receives at least one signal of the plurality of signals when the system circuit is in the to-be-waked phase, wherein each of the plurality of signals is the GPIO signal.

14. A Wake-on-WLAN method execute by a system circuit, the Wake-on-WLAN method comprising:
after the system circuit enters a to-be-waked phase, when the system circuit receives a general-purpose input/output (GPIO) wake-up signal from a Wi-Fi circuit, making the system circuit wake up to determine a type of a wake-up event according to a waveform of the GPIO wake-up signal and to take an action according to the type of the wake-up event,
wherein the waveform of the GPIO wake-up signal varies with the type of the wake-up event, the waveform of the GPIO wake-up signal is a first waveform when the wake-up event is a first event, the waveform of the GPIO wake-up signal is a second waveform when the wake-up event is a second event, and the first waveform is different from the second waveform.

15. The Wake-on-WLAN method of claim 14, further comprising:
before the system circuit enters the to-be-waked phase, when the system circuit receives the GPIO wake-up signal from the Wi-Fi circuit, making the system circuit disregard the GPIO wake-up signal or execute a predetermined procedure.

16. The Wake-on-WLAN method of claim 14, wherein the first waveform includes a first square waveform, the second waveform includes a second square waveform, a width of the first square waveform is different from a width of the second square waveform, and the Wake-on-WLAN method further comprises:
using a central processor of the system circuit to execute firmware to determine a width of the waveform of the GPIO wake-up signal and thereby determining the type of the wake-up event.

17. The Wake-on-WLAN method of claim 14, wherein the first waveform includes a first square waveform, the second waveform includes a second square waveform, a width of the first square waveform is different from a width of the second square waveform, and the Wake-on-WLAN method further comprises:
using a waveform detection hardware circuit of the system circuit to determine a width of the waveform of the GPIO wake-up signal and thereby determining the type of the wake-up event.

18. The Wake-on-WLAN method of claim 14, wherein the system circuit includes at least one of following circuits: a video circuit; and an audio circuit.

19. The Wake-on-WLAN method of claim 18, wherein the system circuit is a television system on a chip (TV SoC), a set-top box integrated circuit (STB IC), or a smart speaker circuit.
